(19) United States
(12) Patent Application Publication
(10) Pub. No.: US 2005/0252539 A1
(43) Pub. Date: Nov. 17, 2005

(54) Vehicular washer nozzle

(75) Inventor: Akira Maruyama, Toyohashi-city (JP)

Correspondence Address: POSZ LAW GROUP, PLC, 12040 SOUTH LAKES DRIVE, SUITE 101, RESTON, VA, 20191, US

(73) Assignee: ASMO CO., LTD.

(21) Appl. No.: 11/127,184

(22) Filed: May 12, 2005

(30) Foreign Application Priority Data
May 17, 2004 (JP) 2004-146586

(51) Int. Cl. B08B 7/04; B08B 3/00; B08B 3/04; B05B 1/10; B60S 1/46

(52) U.S. Cl. 134/123; 239/284.1; 239/284.2

(57) ABSTRACT

A nozzle tip of the washer nozzle has a configuration of a “fluidics type nozzle”. A diffusion angle β (jet angle in a width direction) of diffusive flow diffusively jetted from a diffusive jet port is determined by a ratio E of a cross-sectional area of a liquid inlet port and a cross-sectional area of the diffusive jet port. The diffusion angle β of the diffusive flow is set larger than a predetermined angle W formed by a pair of jet port sidewalls. That is, the diffusive flow jetted from the diffusive jet port at the diffusion angle β, which is determined by the cross-sectional area ratio E, is restricted its diffusion (diffusive limit) by the pair of jet port sidewalls (angle W) disposed downstream of the diffusive jet port.

### CROSS REFERENCE TO RELATED APPLICATION

This application is based upon and claims the benefit of priority of Japanese Patent Application No. 2004-146586 filed on May 17, 2004, the contents of which is incorporated herein by reference.

### FIELD OF THE INVENTION

The present invention relates to a vehicular washer nozzle that jets cleansing liquid to wash a face such as a windshield of a vehicle.

### BACKGROUND OF THE INVENTION

A washer device for cleansing the windshield glass, etc. of a vehicle includes a washer nozzle. Among the washer nozzles, a “fluidics type nozzle” is known as a diffusive jet nozzle for jetting cleansing liquid diffusively in a width direction of the vehicle toward the windshield glass (refer to U.S. Pat. No. 4,463,904-B and its counterpart JP-55-500853-A, for example).

The fluidics type nozzle as disclosed in U.S. Pat. No. 4,463,904-B has a nozzle tip (fluid diffusion element) adopting feedback control flow in the nozzle. The nozzle tip, in which a fluid circuit including a self-oscillation chamber and a control flow passage for self-oscillating the cleansing liquid, can jet the cleansing liquid diffusively in the width direction of the vehicle.

Further, in this kind of conventional fluidics type nozzle (diffusive jet nozzle) as disclosed in U.S. Pat. No. 4,463,904-B, it is known that a ratio between a cross-sectional area of an inlet part of the self-oscillation chamber (referred to as “power nozzle” in U.S. Pat. No. 4,463,904-B) and a cross-sectional area of an outlet part of the self-oscillation chamber (referred to as “throat” in U.S. Pat. No. 4,463,904-B) determines a diffusion angle of the fanned diffusive jet flow.

In such a case of adopting the fluidics type nozzle (diffusive jet nozzle) for supplying the cleansing liquid in a wiper apparatus for jetting the cleansing liquid toward the windshield glass of a vehicle, the cleansing liquid is jetted at a large range of angle by increasing the diffusion angle. The increase of the diffusion angle, however, decreases a velocity vector component in a jet direction of the diffusive jet flow (in a traveling direction of the vehicle) accompanied with an increase of a velocity vector component in a diffusive direction of the jet flow. That is, as the diffusion angle of the jet flow becomes larger, a driving force of the jetted cleansing liquid in a lateral direction (a component of a jet force) increases and a driving force of the jetted cleansing liquid toward the windshield glass (another component of the jet force) decreases. Thus, when the vehicle is traveling at a large speed, the droplets of the jetted cleansing liquid are easily affected by airflow to be sprinkled to a point lower than a desired point, causing an issue of spoiling a desired cleansing performance (adequate cleansing liquid supply).

### SUMMARY OF THE INVENTION

The present invention, in view of the above-described issues, has an object to obtain a vehicular washer nozzle that resolves an imperfection in the conventional fluidics type nozzle (diffusive jet nozzle), jets droplets of the cleansing liquid not easily affected by wind, and capable of sprinkling the diffusion jet flow on desired points to obtain a desired cleansing performance even in a condition such at a large traveling speed.

The vehicular washer nozzle has an oscillation chamber, a liquid inlet port, a diffusive jet port and a pair of jet port sidewalls.

The oscillation chamber is for self-oscillating pressure-fed cleansing liquid. The liquid inlet port is provided at an inlet part of the oscillating chamber and for leading the pressure-fed cleansing liquid into the oscillation chamber. The diffusive jet port is provided at an outlet part of the oscillating chamber to be coaxial with the liquid inlet port and for jetting the cleansing liquid self-oscillated in the oscillation chamber toward a windshield as a diffusive flow diffused in a width direction of a vehicle. The pair of jet port sidewalls contiguous from the diffusive jet port to a jet side and fanning out at a predetermined angle W in the vehicular width direction. The diffusion angle β of the diffusive flow from the diffusive jet port is determined by a ratio E of a cross-sectional area of the liquid inlet port and a cross-sectional area of the diffusive jet port is set to be larger than the predetermined angle W of the pair of the jet port sidewalls.

### BRIEF DESCRIPTION OF THE DRAWINGS

Other objects, features and advantages of the present invention will be appreciated, as well as methods of operation and the function of the related parts, from a study of the following detailed description, the appended claims, and the drawings, all of which form a part of this application. In the drawings:

FIG. 1 is a rear view showing a structure of a nozzle tip of a washer nozzle according to an embodiment of the present invention;

FIG. 2 is a cross-sectional view showing the structure of the nozzle tip of the washer nozzle according to the embodiment of the present invention and taken along a line II-II of FIG. 1;

FIG. 3 is a perspective view showing the structure of the nozzle tip of the washer nozzle according to the embodiment of the present invention;

FIG. 4 is a perspective view showing a structure of the washer nozzle according to the embodiment of the present invention;

FIG. 5 is a plan view showing a jet diffusive state of cleansing liquid jetted by the washer nozzle according to the embodiment of the present invention;

FIG. 6 is a schematic plan view showing a jet diffusive state of cleansing liquid jetted by the washer nozzle according to the embodiment of the present invention;

FIG. 7 is a diagram showing a fan angle W and a cross-sectional area ratio E defined by jet port sidewalls of the washer nozzle according to the embodiment of the present invention;

FIG. 8 is a diagram showing a result of an experiment measuring droplet diameters of the diffusive flow against restriction ratios of the diffusion limit of the jetted diffusive flow in a case of setting the fan angle W defined by the jet port sidewalls to 50 degrees; and

FIG. 9 is a diagram showing a result of an experiment measuring jet speeds of the diffusive flow against restriction ratios of the diffusion limit of the jetted diffusive flow in a case of setting the fan angle W defined by the jet port sidewalls to 50 degrees.

### DESCRIPTION OF THE PREFERRED EMBODIMENTS

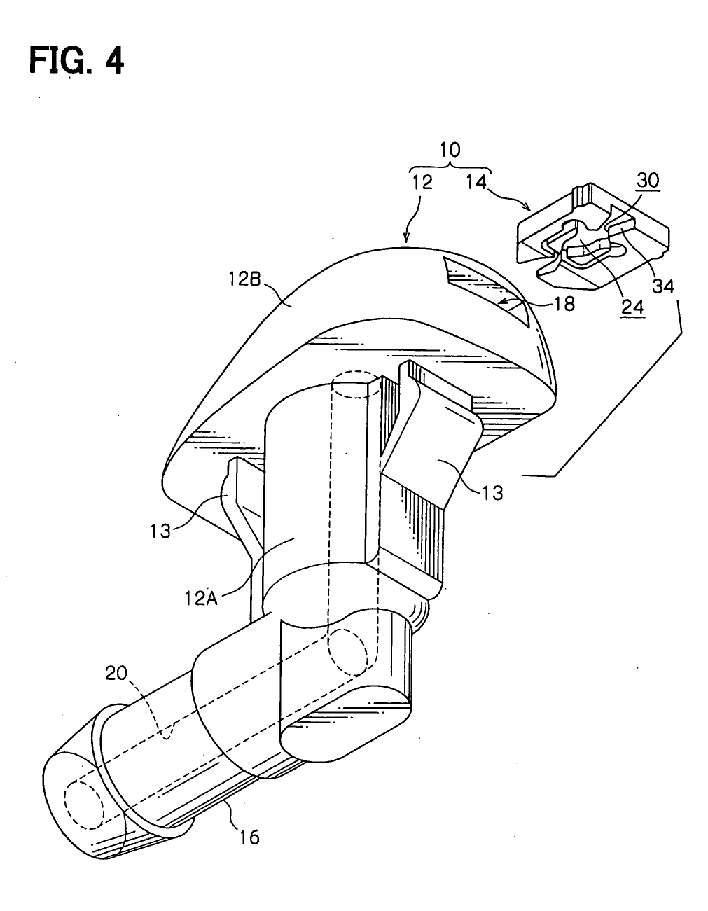

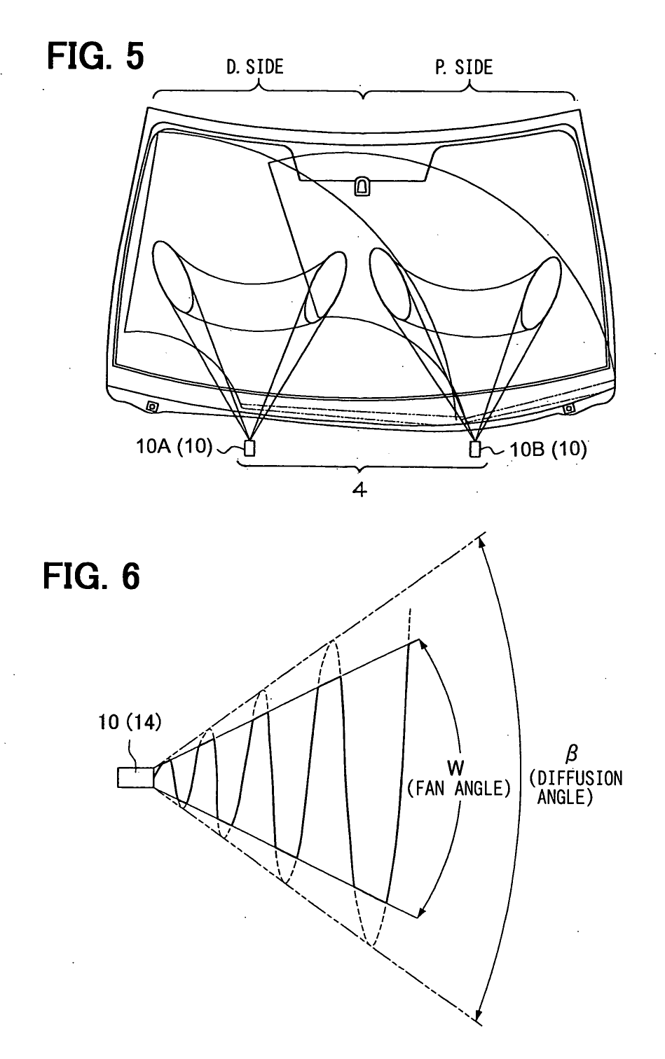

FIG. 4 depicts a perspective view of an entire structure of a (vehicular) washer nozzle 10 according to an embodiment of the present invention. The vehicular washer nozzle 10 is adapted to a first washer nozzle 10A and a second washer nozzle 10B of a window washer device 4 that are disposed apart from each other in a width direction of the vehicle as shown in FIG. 5.

The washer nozzle 10 has a nozzle body 12 and a nozzle tip 14.

The nozzle body 12 is made of a resinous material. A pair of latches 13 extends on a sidewall of a base portion 12A of the nozzle body 12 toward a head portion 12B. The head portion 12B is engaged with and exposed on a body panel (not shown) of the vehicle. A cylinder-shaped hose connection 16 is formed at a bottom end portion of the nozzle body 12 to connect a hose (not shown) between the washer nozzle 10 and a cleansing liquid container tank.

The nozzle body 12 is formed with a tip receiving portion 18 that is opened to a front surface side. A feed passage 20 is formed contiguous to the tip receiving portion 18. One end of the feed passage 20 extends to the hose connection 16.

The nozzle tip 14 formed by resin molding is integrally and fluid-tightly fitted into the tip receiving portion 18.

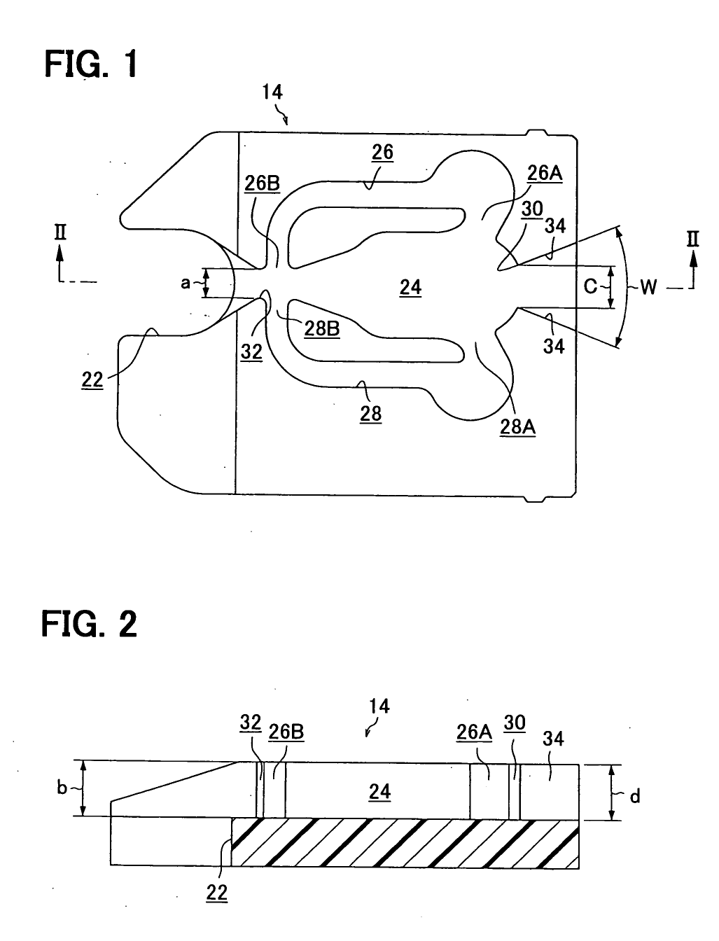

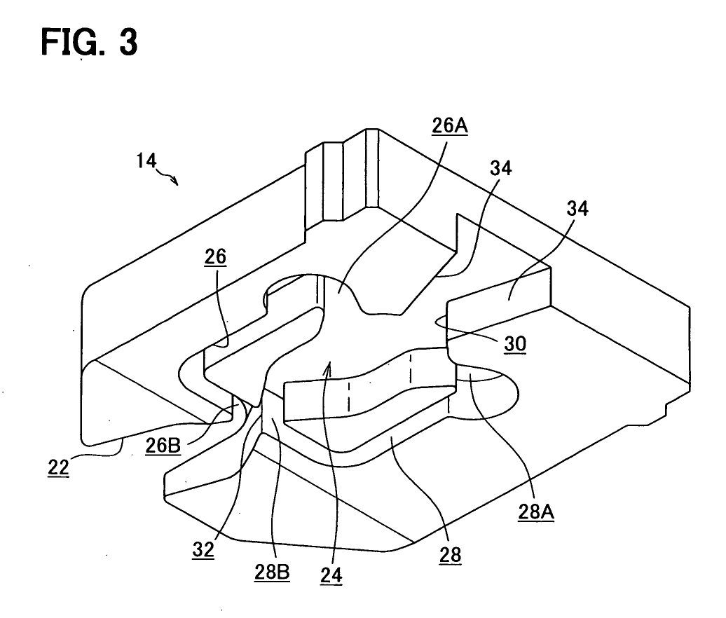

FIG. 1 depicts a rear view of the structure of the nozzle tip 14. FIG. 2 depicts a cross-sectional view of the nozzle tip 14 taken along a line 2-2 of FIG. 1. Further, FIG. 3 depicts a perspective view of the structure of the nozzle tip 14.

The nozzle tip 14 is formed to be substantially box-shaped and formed with a flow passage 22 (forming a part of the feed passage 20) that is communicated to the feed passage 20 in a state of being fitted into the tip receiving portion 18. Furthermore, an oscillation chamber 24 and a pair of feedback flow passages 26, 28 are formed on a lower face side of the nozzle tip 14.

As shown in detail in FIG. 1, the oscillation chamber 24 is formed to be contiguous to the flow passage 22 and provided with a liquid inlet port 32 at an inlet portion thereof to be communicated to the feed passage 20 (the flow passage 22) and to lead the cleansing liquid to the oscillation chamber 24. The cleansing liquid pressure-supplied from the flow passage 22 is fed via the liquid inlet port 32 to the oscillation chamber 21.

Further, the oscillation chamber 24 is provided with a diffusive jet port 30 at an outlet portion thereof to be coaxial with the liquid inlet port 32. Furthermore, a pair of jet port sidewalls 34 is provided at a downstream side (right side in FIG. 1) of the diffusive jet port 30. Both of the jet port sidewalls 34 are formed contiguous from the diffusive jet port to an injection side to face each other and to open fan out at a predetermined angle W in a vehicular width direction.

In the present embodiment, as shown in FIGS. 1, 2 and 6, when it is defined as:
a: a width of the liquid inlet port 32;
b: a height of the liquid inlet port 32;
c: a width of the diffusive jet port 30;
d: a height of the diffusive jet port 30;
E: a ratio of between a cross-sectional area of the liquid inlet port 32 and a cross-sectional area of the diffusive jet port 30,
   That is, (c×d)/(a×b);
β: an intrinsic diffusion angle of the diffusive flow from the diffusive jet port 30 determined by the ratio E; and
W: a fan angle of a pair of jet port sidewalls 34.
   1) As shown in FIG. 6, the diffusion angle β is set to an angle larger than the fan angle W (that is, “β>W”).
   2) The fan angle W is set in a range between 75% and 85% of the diffusion angle β (that is, “0.75β<W<0.85β”).
   3) The fan angle W is set in a range between 42 degrees and 65 degrees (that is, “42 [degrees]<W<65 [degrees]”).
   4) The ratio E is set in a range of:
   (0.0291W−0.2050)≦E≦(0.0329W−0.1397)

A pair of feedback flow passages 26, 28 that branch left and right from the oscillation chamber 24. These feedback flow passages 26, 28 are respectively provided with inlets 26A, 28A formed to open to both a left and right sides of the oscillation chamber 24 upstream of the diffusive jet port 30. Further, the feedback flow passages 26, 28 are respectively provided with outlets 26B, 28B formed to open to both a left and right sides of the oscillation chamber 24 downstream of the liquid inlet port 32 and to be respectively communicated to the inlets 26A, 28A. Accordingly, the feedback flow passages 26, 28 are configured such that a part of the cleansing liquid fed from the flow passage 22 to the oscillation chamber 24 is divided and guided from the inlets 26A, 28A to the outlets 26B, 28B to be returned to the oscillation chamber 24 again. Thereby, the cleansing liquid guided to the feedback flow passages 36 will be a “control flow” to cause self-oscillation of the cleansing liquid flowing in the oscillation chamber 24.

As described above, with the washer nozzle 20, the nozzle tip 14 is a “fluidics type nozzle”. Cleansing liquid self-oscillated in the oscillation chamber 24 is jetted as fan diffusive flow from the diffusive jet port 30 in a relatively wide range in the vehicular width direction to increase a cleansing area.

Next, an operation of the present embodiment will be described.

In the washer nozzle 10 constructed in the manner described above, the cleansing liquid pressure-fed by a washer pump from a tank (not shown) through a hose connection 16 of the nozzle body 12 is led by the feed passage 20 and the flow passage 22, further led through the liquid inlet port 32 to the oscillation chamber 24 of the nozzle tip 14. After the cleansing liquid is lead in the oscillation chamber 24, a part of the cleansing liquid led in the oscillation chamber 24 is separated via each of the inlets 26A, 28A to each of the outlets 26B, 28B of the feedback flow passages 26, 28 (feedback control flow) and returned to the oscillation chamber 24 again. Thus, the cleansing liquid led by the feedback flow passages 26, 28 as a control flow adheres the cleansing liquid flowing in the oscillation chamber 24 to left and right sidewalls of the oscillation chamber 24 alternately to generate an eddy and to self-oscillate the cleansing liquid. The self-oscillated cleansing liquid is diffusively jetted from the diffusive jet port 30 as a fan diffusive flow as shown in FIG. 5. Thus, the washer nozzle 10 is able to jet the cleansing liquid to a large area as a fan diffusive flow from the diffusive jet port 30.

Here, the diffusion angle β(jet angle in the width direction) of the diffusive flow jetted from the diffusive jet port 30 is determined by a ratio E of a cross-sectional area of the liquid inlet port 32 and a cross-sectional area of the diffusive jet port 30 (refer to the above-described U.S. Pat. No. 4,463,904-B). In the washer nozzle 10 according to the present embodiment, as shown in FIG. 6, the diffusion angle β of the diffusive flow is set to be larger than the predetermined angle W of the pair of the jet port sidewalls 34. That is, the diffusive flow jetted from the diffusive jet port 30 at a diffusion angle β determined by the cross-sectional area ratio E is jetted to be restricted an diffusion (diffusive limit) thereof by the pair of jet port sidewalls 34 (angle W) provided downstream of the diffusive jet port 30.

Accordingly, a diffusion angle restriction of the diffusive jet flow causes a retention of the cleansing liquid at both ends in a jet width thereof to densify droplets of the cleansing liquid. Thus, at both ends in the jet width, the densified droplets of the cleansing liquid increases each of the droplet diameters to increase kinetic energy per one of the droplets. As a result, the droplet is not easily affected by wind. Thus, it becomes possible to sprinkle the cleansing liquid on desired points to derive a desired cleansing performance even at a large traveling speed.

Here, as described above, for the droplets of the cleansing liquid not to be easily affected by wind, it is desirable that a kinetic energy per one of the droplets is large. Thus, it is desirable that the droplet diameters and the jet speeds are large. Further, in an ordinal condition, the jet angle in a diffusive direction (width direction) of this kind of diffusive injection nozzle suitable for usages in vehicle is in a range between 42 degrees and 65 degrees. That is, when the jet angle is too small, the cleansing water may be sprinkled out and when the jet angle is too small, a suitable large sprinkle area cannot be achieved. Further, the predetermined angle W determined by a pair of the jet port sidewalls in the washer nozzle of the present invention is desirable to be in an angle between 75% and 85% of the diffusion angle (jet angle in the width direction) β of the diffusive flow.

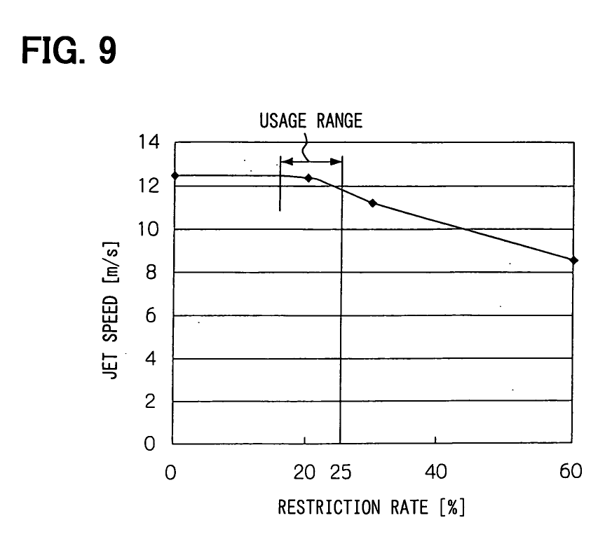

That is, FIG. 8 depicts a result of an experiment measuring droplet diameters of the diffusive flow against the restriction ratios of diffusion (diffusion limit) of the jetted diffusive flow (jet flow) in a case of setting the fan angle W determined by the jet port sidewalls 34 to 50 degrees. As apparent from the FIG. 8, a range hardly decreasing the droplet diameter is a range in which the restriction ratio is not smaller than 15%. FIG. 9 depicts a result of an experiment measuring jet speeds of the diffusive flow against the restriction ratios of diffusion (diffusion limit) of the jetted diffusive flow (jet flow) in a case of setting the fan angle W determined by the jet port sidewalls 34 to 50 degrees. As apparent from the FIG. 9, a range hardly decreasing the jet speed is a range in which the restriction ratio is not larger than 25%. Thus, the restriction ratio in which the regulation of the diffusion (retention of the cleansing liquid) is executed to increase the respective droplet diameters and in which the jet speed is equivalent to those when the regulation of the diffusion is not executed is found to be a range between 25% and 15% of an instinct diffusion angle β determined by the cross-sectional area ratio E.

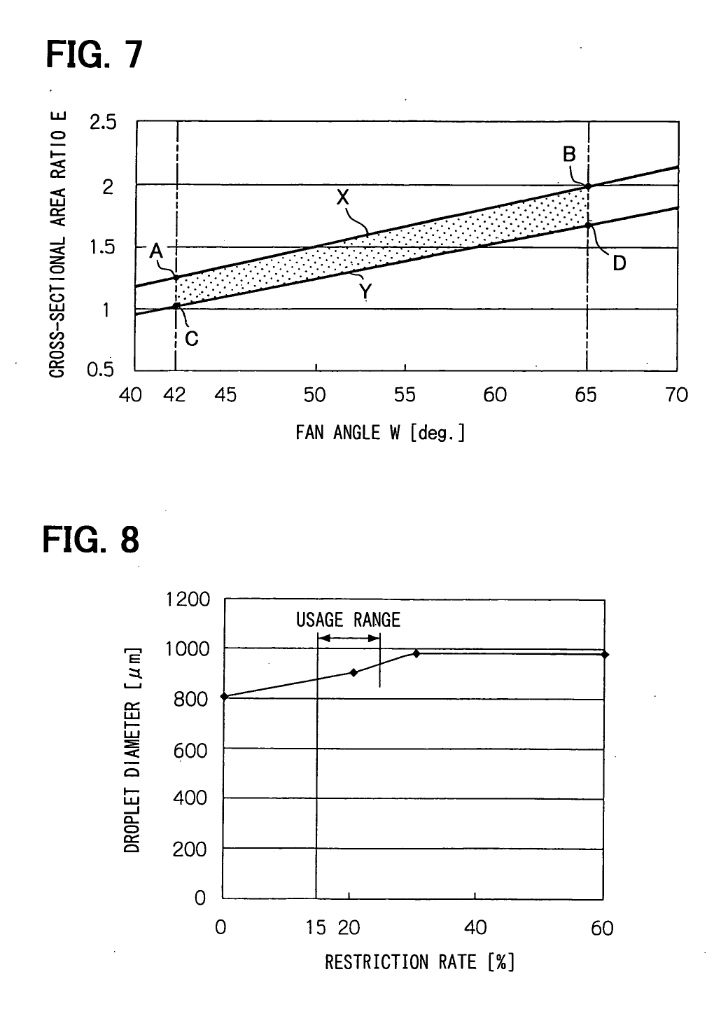

Regarding this point, in the washer nozzle 10 according to the present invention 10, the fan angle W of a pair of the jet port sidewalls 34 is set to an angle between 75% and 85% of the diffusion angle β of the diffusive flow. In other words, the diffusion restriction ratio of the diffusive flow is between 25% and 15%. Additionally, as shown in FIG. 7, the fan angle W is set in a range between 42 degrees and 65 degrees and the ratio E is set in a range of (0.0291W−0.2050)≦E≦(0.0329W−0.1397).

That is, as an upper limit when the angle W is 75% of the diffusion angle β, the ratio E is restricted as E≦(0.0329W−0.1397) based on a line X determined by a point A (42 degrees, 1.2421) and a point B (65 degrees, 1.9988) in FIG. 7. Further, as a lower limit when the angle W is 85% of the diffusion angle β, the ratio E is restricted as E≧(0.0291W−0.2050) based on a line Y determined by a point C (42 degrees, 1.0172) and a point D (65 degrees, 1.6865) in FIG. 7.

Thus, the range of the angle W is identified in which a jet speed decrease of the droplet is minimized and a jet speed is hardly decreased. (The range of the angle W is identified in which both the droplet diameter and the jet speed of the droplet water are satisfied.)

Accordingly, it is possible to increase the droplet diameters by jetting the cleansing liquid at a jet speed equivalent to that in which a retention of the cleansing liquid is not executed at both ends in a diffusion width of the jetted diffusive flow (jet flow). As a result, it is possible to jet droplets of which a kinetic energy is kept to be large to reduce the effect of wind.

This description of the invention is merely exemplary in nature and, thus, variations that do not depart from the gist of the invention are intended to be within the scope of the invention. Such variations are not to be regarded as a departure from the spirit and scope of the invention.

1. A vehicular washer nozzle having:
an oscillation chamber for self-oscillating pressure-fed cleansing liquid;
a liquid inlet port provided at an inlet part of the oscillating chamber and for leading the pressure-fed cleansing liquid into the oscillation chamber;
a diffusive jet port provided at an outlet part of the oscillating chamber to be coaxial with the liquid inlet port and for jetting the cleansing liquid self-oscillated in the oscillation chamber as a diffusive flow diffused in a width direction of a vehicle; and
a pair of jet port sidewalls contiguous from the diffusive jet port to a jet side and fanning out at a predetermined angle W in the vehicular width direction,
wherein a diffusion angle β of the diffusive flow from the diffusive jet port determined by a ratio E of a cross-sectional area of the liquid inlet port and a cross-sectional area of the diffusive jet port is set to be larger than the predetermined angle W of the pair of the jet port sidewalls.

2. The vehicular washer nozzle according to claim 1, characterized in comprising:
a feed passage in communication with the liquid inlet port and for feeding the pressure-fed cleansing liquid to the liquid inlet port; and
a left-and-right pair of feedback flow passages having:
inlets opening at both left and right sides of the oscillation chamber upstream of the diffusive jet port; and
outlets opening at both left and right sides of the oscillation chamber downstream of the inlet port, the feedback flow passages respectively returning a part of the cleansing liquid lead into the oscillation chamber from the inlets to the outlets.

3. The vehicular washer nozzle according to claim 1, wherein the predetermined angle W of the pair of the jet port sidewalls is between 75% and 85% of the diffusion angle β determined by the ratio E.

4. The vehicular washer nozzle according to claim 1, wherein:
the predetermined angle W is in a range between 42 degrees and 65 degrees; and
the ratio E is in a range of (0.0291W−0.2050)<E<(0.0329W−0.1397).

5. A vehicular washer nozzle according to claim 1, the vehicular washer nozzle being adapted to a vehicular washer device.

6. The vehicular washer nozzle according to claim 5, the vehicular washer nozzle being adapted to a first washer nozzle and a second washer nozzle which are disposed apart from each other in the width direction of the vehicle.
